(19) United States
(12) Patent Application Publication
(10) Pub. No.: US 2022/0360613 A1
(43) Pub. Date: Nov. 10, 2022

(54) ANNOTATIONS FOR VIRTUAL PRESENTATION SESSIONS

(71) Applicant: Cisco Technology, Inc., San Jose, CA (US)

(72) Inventors: Manoj Papisetty, Telangana (IN); Prapanch Ramamoorthy, Bangalore (IN); Akshay Dubey, Karnataka (IN)

(21) Appl. No.: 17/313,547

(22) Filed: May 6, 2021

(51) Int. Cl. H04L 29/06; H04L 12/18; G06F 40/169

(52) U.S. Cl. CPC H04L 65/4015; H04L 12/1831; H04L 65/403; G06F 40/169

(57) ABSTRACT

A method, computer system, and computer program product are provided for providing annotations in virtual presentation sessions. Content is presented to a plurality of user devices participating in a communication session. Annotations to the content are received from a plurality of users of the plurality of user devices during the communication session. A subset of one or more users is selected. The annotations associated with the subset of one or more users are provided to the plurality of user devices to cause the plurality of user devices to display the annotations of the subset of one or more users.

### TECHNICAL FIELD

The present disclosure relates to virtual presentation sessions, and more specifically, to controlling user access to annotations during virtual presentation sessions.

### BACKGROUND

Users, particularly in an enterprise or classroom setting, engage in virtual presentations, such as slideshow presentations, to share information with other users. Participants may provide their own digital annotations to a presentation in order to emphasize important details, write down answers to questions, make reminders for further study, and the like. In order to facilitate collaboration among users, it is desirable to enable the users to share their annotations with other users during presentations in a controlled manner.

### BRIEF DESCRIPTION OF THE DRAWINGS

FIG. 1 is a block diagram depicting an environment for implementing annotations in virtual presentation sessions, in accordance with an example embodiment.

FIG. 2A is a user interface diagram depicting a screen or view of presentation content including annotations of one user, in accordance with an example embodiment.

FIG. 2B is a user interface diagram depicting a screen or view of presentation content including annotations of multiple users, in accordance with an example embodiment.

FIG. 3 is a flow chart depicting a method for selectively enabling annotations in a communication session, in accordance with an example embodiment.

FIG. 4A is a user interface diagram depicting a screen or view of a user including public and personal annotations made by the user, in accordance with an example embodiment.

FIG. 4B is a user interface diagram depicting a screen or view of another user including public annotations, in accordance with an example embodiment.

FIG. 5 is a flow chart depicting a method for annotating presentation content, in accordance with an example embodiment.

FIG. 6 is a block diagram depicting a computing device configured to participate in virtual presentation sessions, in accordance with an example embodiment.

### DESCRIPTION OF EXAMPLE EMBODIMENTS

### Overview

According to one embodiment, techniques are provided for providing annotations in virtual presentation sessions in which multiple users are participating. Content is presented to a plurality of user devices participating in a communication session. Annotations to the content are received from a plurality of users of the plurality of user devices during the communication session. A subset of one or more users is selected. The annotations associated with the subset of one or more users are provided to the plurality of user devices to cause the plurality of user devices to display the annotations of the subset of one or more users.

### EXAMPLE EMBODIMENTS

Embodiments are provided for virtual presentation sessions, and more specifically, to controlling user access to annotations during virtual presentation sessions.

Remote education has become a way of life for most countries today due to the pandemic. The current gap between in-person education and online education is significant due to the difficulty of providing virtual counterparts for in-person interactions and experiences. One feature of some virtual presentation software is the ability to provide annotations to portions of a presentation. Annotations can include text comments, highlighting, drawings, freehand notes, digital marginalia, and any other mark-up that can be applied to a document. For example, using annotations, a trainer/teacher is able to engage with students to perform classroom exercises by circling portions of text, inserting notes, and the like. Thus, a trainer/teacher can replicate the in-person experience of writing notes on a whiteboard and asking students to provide feedback.

However, there are challenges associated with conventional approaches to annotations that hinder the virtual delivery of educational content. First, all participants can see annotations from the other participants. With an increase in student count, it becomes very difficult for the trainer to differentiate the annotations. This can make educating students difficult, as a student can easily plagiarize annotations done by other students. Additionally, conventional approaches to annotations do not enable an administrator to group users and allow grouped users to collaborate among themselves using annotations.

In other use cases, such as online meetings and training seminars, attendees/students often need to take notes in-line with what is being presented or shared. However there is no mechanism available within the meeting platform today to take notes in-line with shared content. Thus, users may depend on other third party systems to take notes. For instance, users might take a screenshot or open up a text editor and write down notes. Presented embodiments aim to address the challenges above to make learning more inclusive and to improve the overall experience of both the host and attendees of online training or instructional sessions and meetings.

Accordingly, present embodiments provide a practical application of improving document/content annotation in multi-user communication sessions. In particular, present embodiments enable control of access to annotations on a per-user basis, thus enabling selective display of annotations at any desired level of granularity. By controlling which user annotations are visible to other users, collaboration among participants in a virtual presentation session can be greatly enhanced.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

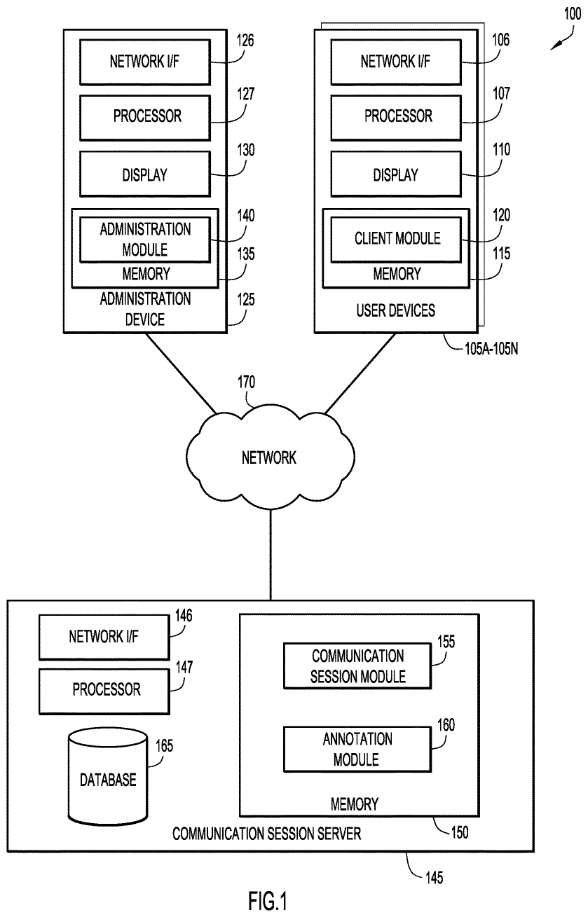

Embodiments are now described in detail with reference to the figures. FIG. 1 is a block diagram depicting an environment 100 for implementing annotations in virtual presentation sessions in accordance with an example embodiment. As depicted, environment 100 includes user devices 105A-105N, an administrator device 125, a communication session (collaboration) server 145, and a network 170. It is to be understood that the functional division among components of environment 100 have been chosen for purposes of explaining various embodiments and is not to be construed as a limiting example.

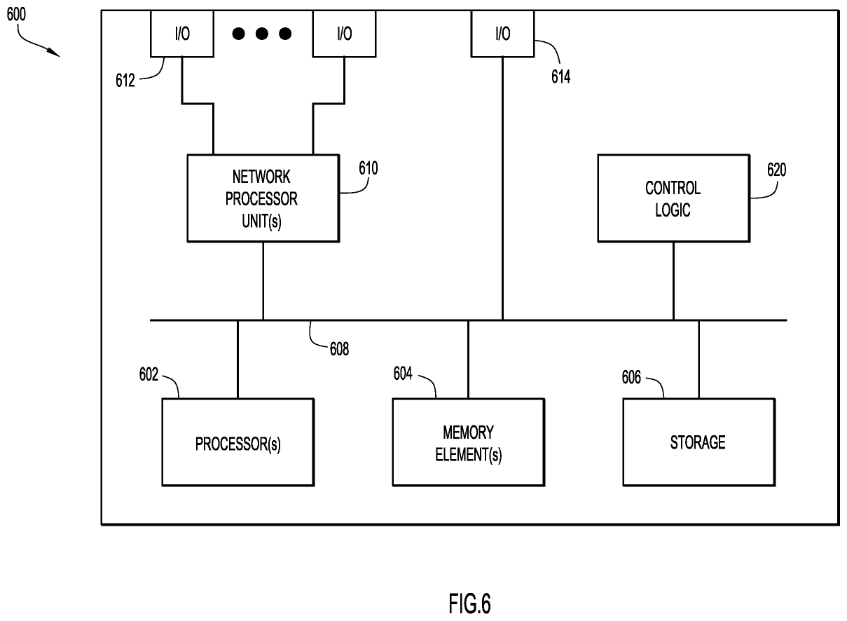

Each user device 105A-105N includes a network interface 106, at least one processor 107, a display 110, and memory 115. Memory 115 stores software instructions for a client module 120. Each user device 105A-105N may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 106 enables components of user devices 105A-105N to send and receive data over a network, such as network 170. Network interface 106 may take the form of a wired network interface card/adapter, wireless network interface card/adapter, or other network interface hardware and associated software now known or hereinafter developed that enables network connectivity. User devices 105A-105N may include internal and external hardware components, as depicted and described in further detail with respect to FIG. 6. In general, a participant in a communication session may utilize any of user devices 105A-105N in order to view content (e.g., documents or other media), collaborate with other users, annotate content, share annotations with other users, view other users' annotations, and the like.

Display 110 may include any electronic device capable of presenting information in a visual form. For example, display 110 may be a liquid crystal display (LCD), a cathode ray tube (CRT) display, a light-emitting diode (LED) display, an electronic ink display, and the like. Data relating to communication sessions, such as document data and/or annotation data, may be presented to users of user devices 105A-105N via display 110.

Client module 120 may include one or more modules or units to perform various functions of present embodiments described below. Client module 120 may be implemented by any combination of any quantity of software and/or hardware modules or units, and may reside within memory 115 of user devices 105A-105N for execution by a processor, such as processor 107.

Client module 120 enables a user of any user device 105A-105N to participate in a communication session, which may include viewing content (e.g., documents or other media), annotating content, viewing annotations of other users, and any other collaborative actions, such as communicating with other users via audio, video, and/or text, sharing files between users, and the like. In some embodiments, client module 120 may present data to a user that is received from another computing device belonging to a host of the communication session. Client module 120 may receive communication session data from one or more locations, including another user device of user devices 105A-105N, administrator device 125, and/or communication session server 145.

Communication session data that is received by client module 120 may correspond to any viewable content that can be presented to users, such as a text document, a slideshow presentation, or other text or multi-media documents. In some embodiments, client module 120 receives data that is streamed from a computing device of a host, causing the view of users of user devices 105A-105N to be updated in response to the host changing his or her view of the content. In some embodiments, client module 120 may receive a document during a communication session and a user may partially or fully navigate independently throughout the document. In some embodiments, client module 120 may receive an entire document during a communication session, and client module 120 may receive instructions during the communication session that cause client module 120 to present particular views of the document to the user.

Client module 120 enables a user to annotate content that is presented by client module 120 during a communication session. In various embodiments, a user may interact with presented content to add annotations, including, but not limited to, text, highlighting, underlining, comments, handwriting, or any other markup to content. Additionally, a user may edit or delete any annotations added by the user. Client module 120 may transmit data corresponding to user annotations to one or more network-accessible locations, such as administrator device 125 and/or communication session server 145. Client module 120 may receive data corresponding to the annotations of one or more other users participating in a communication session in order to present the annotations of other users to a user at the user's own computing device.

Annotations may be saved as annotation data in which the annotations are defined using any conventional or other approaches to document annotation. In some embodiments, annotation data may include document metadata that indicates a type of annotation (e.g., text, highlighting color, underlining, etc.), content of an annotation, if applicable (e.g., text of a comment), and/or a portion of the content (e.g., a document or other media) to which the annotation is applied. Annotation data can specify portions of content using a coordinate system, based on a position in the content with reference to a character, word, paragraph, page, etc., or according to any other approach to applying annotations to content. When a user adds an annotation to content, client module 120 may save the annotation data locally at the user device and/or may transmit the annotation data to a network-accessible location, such as administrator device 125 and/or communication session server 145. In some embodiments, a user may indicate whether annotations are subject to being shared with other users or are viewable only to the user. For example, a public annotation mode may record a user's annotations and enable those annotations to be shared with other users, whereas a personal annotation mode may prevent annotations from being viewed by other users.

Administrator device 125 includes a network interface 126, at least one processor 127, a display 130, and memory 135. Memory 115 stores software instructions for an administration module 140. Administrator device 125 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 126 enables components of administrator device 125 to send and receive data over a network, such as network 170. Administrator device 125 may include internal and external hardware components, as depicted and described in further detail with respect to FIG. 6. In general, a user of administrator device 125 (e.g., an administrator, host, or presenter of a presentation) may participate in communication sessions similarly to users of user devices 105A-105N, as well as perform administrative actions, such as controlling the presentation of documents and/or annotations to users participating in communication sessions. Thus, the user of administrator device 125 may be an instructor of students, a presenter of a business meeting, or a similar individual who has assumed some leadership over, or responsibility toward, the other participants in a communication session.

Display 130 may include any electronic device capable of presenting information in a visual form. For example, display 130 may be take on any of the forms described above for display 110. Data relating to communication sessions, such as content data, annotation data, and/or administration data, may be presented to a user of administrator device 125 via display 130.

Administration module 140 may include one or more modules or units to perform various functions of present embodiments described below. Administration module 140 may be implemented by any combination of any quantity of software and/or hardware modules or units, and may reside within memory 135 of administrator device 125 for execution by a processor, such as processor 127.

Administration module 140 enables a user of administrator device 125 to control the presentation of viewable content during a communication session and/or the display of annotations to users participating in the communication session. Initially, administration module 140 may include some or all of the functionality of client module 120, such as viewing a document, adding or editing annotations, and the like. Additionally or alternatively, administration module 140 may enable a user of administrator device 125 to view annotations of each user of user devices 105A-105N and to select annotations of one or more users to be displayed to other users.

In some embodiments, administration module 140 receives input from a user of administrator device 125 to control the presentation of data to user devices 105A-105N during a communication session. Administration module 140 may, based on user input, transmit instructions that cause particular documents or portions of documents to be displayed to users of user devices 105A-105N. Thus, a user of administrator device 125 may guide a communication session by selecting the data that is presented to users via display 110 of user devices 105A-105N over the course of the communication session.

In addition to controlling the display of presentation content (e.g., documents) to participants in a communication session, administration module 140 enables an administrator of a communication session to select one or more users in order to cause the annotations of those users to be presented to other users participating in the communication session. An administrator may provide input corresponding to the identities of one or more users, causing annotations of those users to be added to the content being viewed by other users. A user may also be deselected to cause annotations of that user to no longer be visible to the other users. In various embodiments, administration module 140 may access user devices 105A-105N and/or communication session server 145 to obtain annotation data and to provide other user devices 105A-105N with annotation data.

Communication session server 145 includes a network interface (I/F) 146, at least one processor 147, memory 150, and database 165. Memory 150 stores software instructions for a communication session module 155 and an annotation module 160. Communication session server 145 may include a rack-mounted server or any other programmable electronic device capable of executing computer readable program instructions. Network interface 146 enables components of communication session server 145 to send and receive data over a network, such as network 170. In general, communication session server 145 supports communication sessions between administrator device 125 and/or user devices 105A-105N, records user annotations, and provides annotations to user devices 105A-105N.

Communication session server 145 may include internal and external hardware components, as depicted and described in further detail with respect to FIG. 6.

Communication session module 155 and annotation module 160 may include one or more modules or units to perform various functions of present embodiments described below. Communication session module 155 and annotation module 160 may be implemented by any combination of any quantity of software and/or hardware modules or units, and may reside within memory 150 of communication session server 145 for execution by a processor, such as processor 147.

Communication session module 155 supports communication sessions by enabling participants to join a communication session and view documents being presented during the communication session, as well as receive any other communication session data. Users of user devices 105A-105N may authenticate their identity with their respective user device and join a communication session via client module 120. When a communication session is established, communication session module 155 may provide participating devices, including administrator device 125 and user devices 105A-105N, with content data, such as one or more documents being presented during the communication session. Communication session module 155 may provide data to each client module 120 of user devices 105A-105N based on instructions received from administrator device 125 so that an administrator can control the presentation of one or more documents during a communication session. For example, communication session module 155 may provide data to user devices 105A-105N to cause the user devices to display a particular portion of a document.

Annotation module 160 may receive annotation data from user devices 105A-105N and store the annotation data in a manner that associates each annotation with the specific user who authored the annotation. As users of user devices 105A-105N annotate documents during a communication session, the annotation data is transmitted to communication session server 145, either in an ad hoc fashion as the annotation data is made available, or according to a predetermined schedule. In some embodiments, the annotation data is saved in database 165. When communication session server 145 receives a request from administrator device 125 to make annotations of certain users available to other users, annotation module 160 may identify annotation data corresponding to the annotations of those users, and may then provide the identified annotation data to user devices 105A-105N. In some embodiments, when the annotations of users are no longer desired to be displayed to other users, annotation module 160 may transmit instructions to user devices 105A-105N to cause the annotations of the identified users to no longer be displayed to the other users of user devices 105A-105N.

Database 165 may include any non-volatile storage media known in the art. For example, database 165 can be implemented with a tape library, optical library, one or more independent hard disk drives, or multiple hard disk drives in a redundant array of independent disks (RAID). Similarly, data in database 165 may conform to any suitable storage architecture known in the art, such as a file, a relational database, an object-oriented database, and/or one or more tables. Database 165 may store data relating to communication sessions, including relationships between users and user devices 105A-105N, document data, and annotation data.

Network 170 may include a local area network (LAN), a wide area network (WAN) such as the Internet, or a combination of the two, and includes wired, wireless, or fiber optic connections. In general, network 170 can be any combination of connections and protocols known in the art that will support communications between user devices 105A-105N, administrator device 1252, and/or communication session server 145 via their respective network interfaces in accordance with the described embodiments.

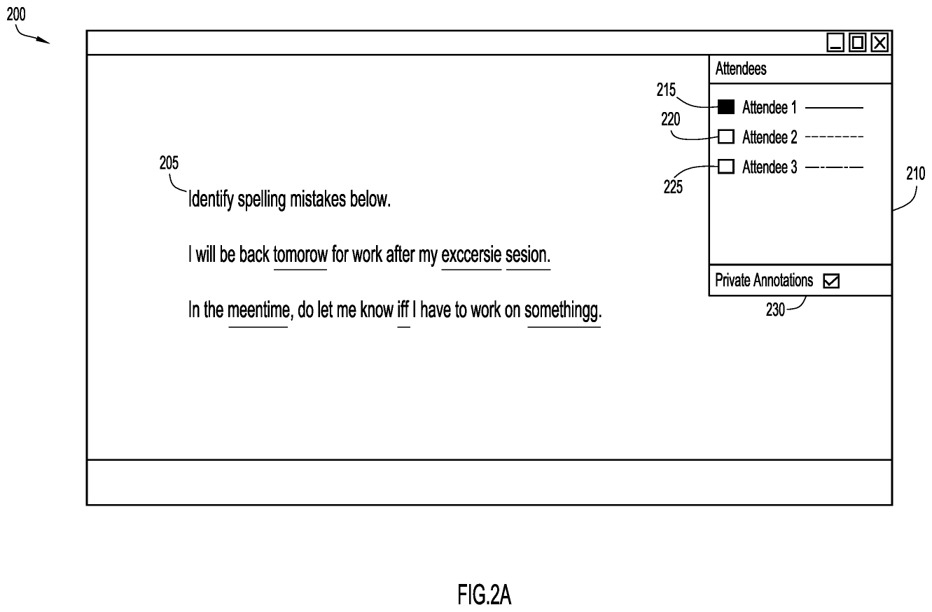

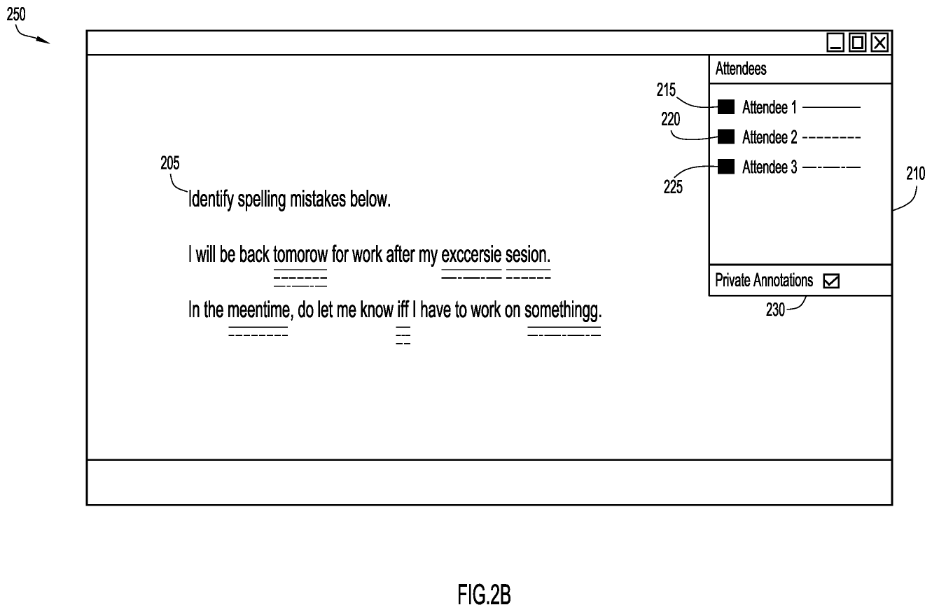

Referring to FIG. 2A, FIG. 2A is a user interface diagram depicting a screen or view 200 of presentation content including annotations of one user, in accordance with an example embodiment. As depicted, view 200 includes a document 205, a user panel 210 with individual user annotation indicators 215, 220, and 225, and a personal annotations indicator 230.

User panel 210 is a user interface element that shows participants of a communication session by user. User panel 210 may further include an example, for each user, of the user's annotation style; in the depicted embodiment, the user named Attendee 1 is associated with a solid line, whereas the user Attendee 2 is associated with a dashed line, and the user Attendee 3 is associated with a dash-dotted line. Additionally, a user annotation indicator may be associated with each user's name in order to indicate whether that user's annotations are visible to other participants of a communication session. As shown in view 200, the user annotation indicator 215 is activated, indicating that the annotations of the user named Attendee 1 are currently being presented at document 205 to the other participants. Thus, the underlining added to document 205 corresponds to annotations by the user identified as Attendee 1.

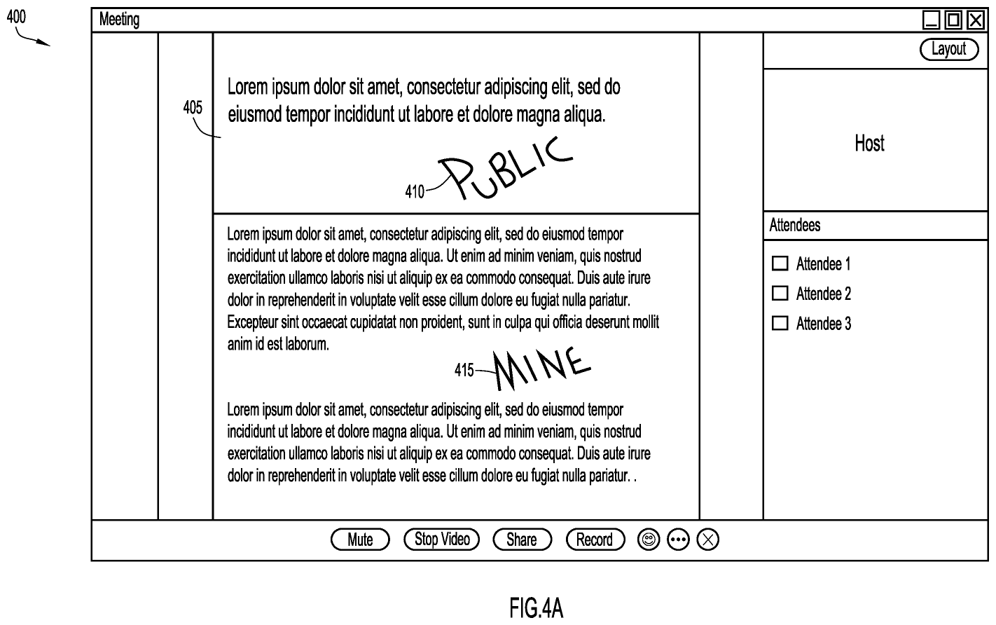

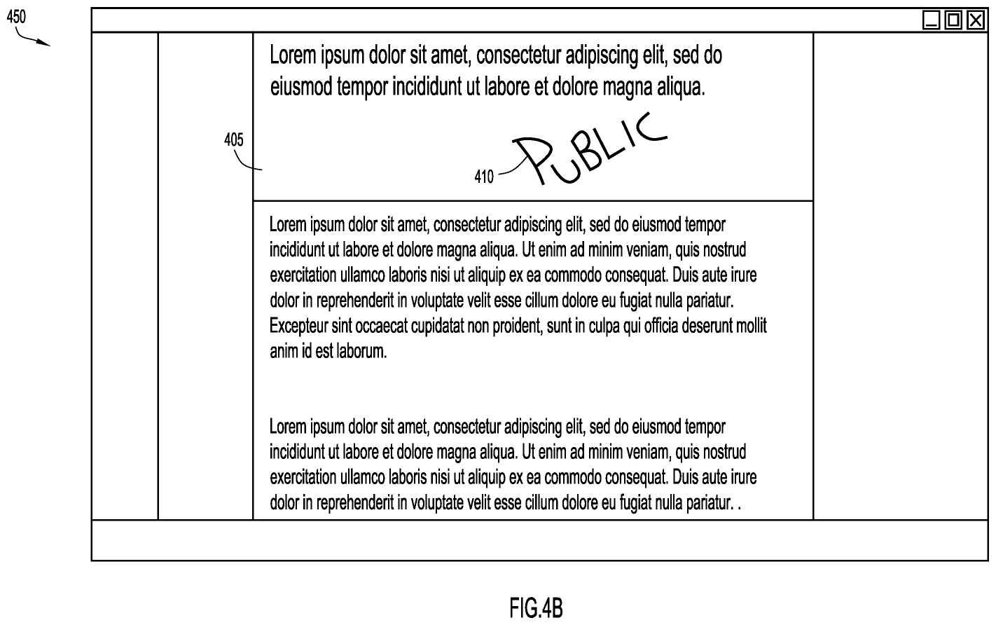

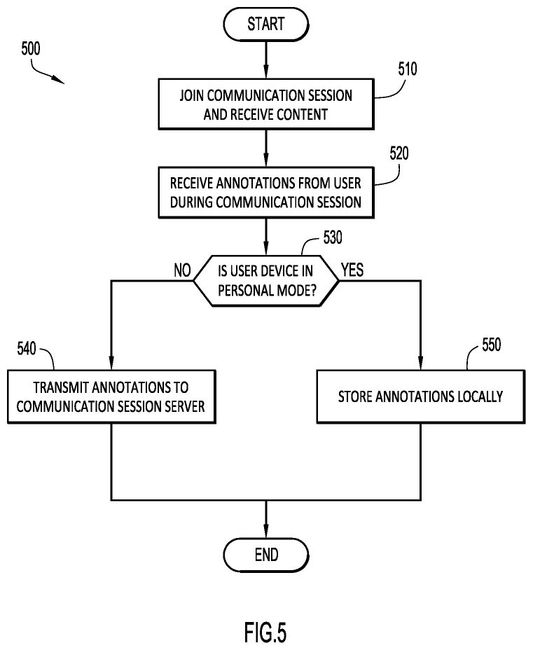

View 200 may be presented to a user of any of user devices 105A-105N and/or may be presented to a user of administrator device 125. In some embodiments, a user of administrator device 125 may interact with user annotation indicators 215, 220, and 225 in order to selectively enable or disable visibility of each user's comments to the other users. Personal annotations indicator 230 may indicate whether personal annotations are enabled or disabled for participants; when enabled, users may enter a personal annotation mode and make annotations to documents that may not be made visible to other users. Personal annotations are depicted and described in further detail with respect to FIGS. 4A, 4B, and 5.

Referring to FIG. 2B, FIG. 2B is a user interface diagram depicting a screen or view 250 of a presentation content including annotations of multiple users, in accordance with an example embodiment. View 250 depicted in FIG. 2B may correspond to a user interface, such as the user interface shown in view 200, after an administrator changes the selection of users, causing a different set of users' annotations to be visible to participants. As shown in user panel 210 of view 250, user annotation indicators 215, 220, and 225 have been enabled, causing annotations of users Attendee 1, Attendee 2, and Attendee 3 to all be displayed on document 205. In some embodiments, annotations of each user may be distinguished from those of other users by using a visual indicator, such as a color scheme, hatching, and the like. In the depicted embodiment, the user Attendee 1 is associated with a solid line, whereas the user Attendee 2 is associated with a dashed line, and the user Attendee 3 is associated with a dash-dotted line. Thus, a participant can readily distinguish between the annotations of Attendee 1, Attendee 2, and Attendee 3 based on the different line styles.

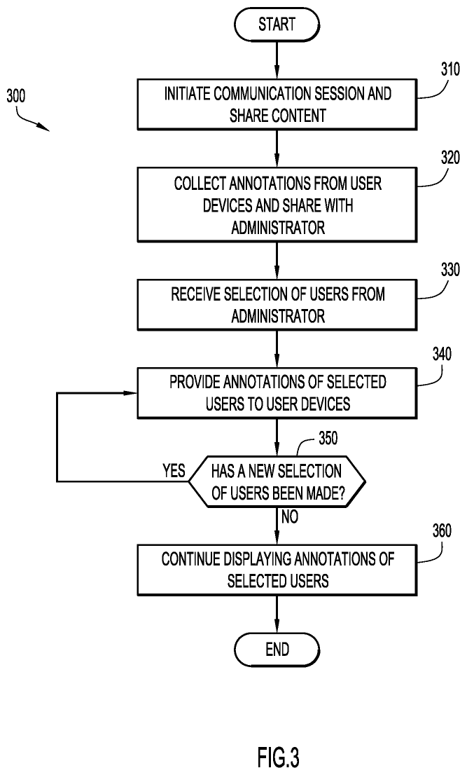

Referring to FIG. 3, FIG. 3 is a flow chart depicting a method 300 for selectively enabling annotations in a communication session, in accordance with an example embodiment.

A communication session is initiated and viewable content is shared at operation 310. A communication session may be initiated between a group of users, such as users of user devices 105A-105N. Additionally, a user may join via administrator device 125 in order to oversee the presentation of documents and/or annotations to the other users. Once a communication session begins, the same viewable content, such as a document, may be shared to all users of user devices 105A-105N, along with other data, such as audio and/or video data obtained from a presenter or host. During the course of the communication session, users of user devices 105A-105N may add, edit, and/or remove their own annotations to the viewable content, including text, drawings, underlining, highlighting, or any other markup.

Annotations from user devices are collected and shared with an administrator at operation 320. As users annotate the viewable content, the annotations may be collected and stored by a server, such as communication session server 145, and shared with an administrator for review. The administrator may view each user's annotations in order to determine annotations that are suitable for sharing with the other participants during the communication session. For example, a document may include a math problem, and an administrator may request the participating users to solve the math problem and to add annotations to the document to show their work; the administrator can then view each user's work to track their progress.

A selection of users is received from the administrator at operation 330. The administrator may, upon review of the annotations provided by users, desire to share one or more users' annotations with the rest of the users participating in the communication session. The administrator may indicate a selection of users, and the annotations of the selected users are provided to the other user devices at operation 340. In some embodiments, each user's annotations are received and stored by communication session server 145, and when the administrator selects a user's annotations to be shared with the other users, communication session server 145 provides that user's annotation data to user devices 105A-105N to enable each user to see the selected user's annotations applied to their view of a document.

Operation 350 determines whether a new selection of users has been made. An administrator may wish to show another user's annotations, or may desire to add or remove a user from a group of selected users, and so may modify the selection of users. When a new selection of users is made, the annotations of the new selection of users is provided to user devices 105A-105N at operation 340. Thus, an administrator may control the display of annotations of users during a communication session in order to facilitate collaboration among participants. Otherwise, if there is no new selection of users, then user devices 105A-105N continue to display the selected user annotations at operation 360.

Referring to FIG. 4A, FIG. 4A is a user interface diagram depicting a screen or view 400 of a user including public and personal annotations made by the user, in accordance with an example embodiment. As depicted, view 400 shows a document 405 with a public annotation 410 and a personal annotation 415.

A user of any of user devices 105A-105N may make annotations to viewable content in either a public mode or a personal mode. Annotations made while a user is in public mode may not necessarily be visible to other users, but can be shared and accordingly made visible to the other users when the user's annotations are selected for display (e.g., by an administrator). Thus, public annotation 410 shows a free-hand annotation that a user has applied to document 405. In contrast, personal annotation 415 may represent an annotation that the user has provided while the user has entered a personal annotation mode. Personal annotation 415 may be stored locally at the user's device, and may not be made available to communication session server 145 or otherwise provided to user devices 105A-105N. Thus, a user may make annotations to documents that the user desires to remain private or confidential.

Referring to FIG. 4B, FIG. 4B is a user interface diagram depicting a screen or view 450 of another user including public annotations, in accordance with an example embodiment. View 450 may depict a view of another user; in the depicted example, the user who provided annotations 410 and 415 in view 450 has been selected to have his or her annotations shared with the other user who is being presented view 450. Thus, the other user may only view public annotation 410, as private annotation 415 is not uploaded to a server or otherwise made available to the other user devices 105A-105N. Accordingly, only public annotation 410 is visible to the other user who is being presented view 450.

Referring to FIG. 5, FIG. 5 is a flow chart depicting a method 500 for annotating presentation content, in accordance with an example embodiment.

A user device joins a communication session and receives data corresponding to presentation content at operation 510. When a user joins a communication session, his or her user device begins to receive data corresponding to presentation content, such as a document, and optionally, additional data such as audio and/or video data from a host or other participating users, annotation data corresponding to other participating users, and the like.

Annotations are received from the user during the communication session at operation 520. As the user interacts with the presented content during the communication session, the user may provide input corresponding to annotations, which are received by the user device.

Operation 530 determines whether the user device is in a personal mode. In some embodiments, a user may toggle the annotation mode between a personal mode and a public mode at any time. In some embodiments, instructions are received from a device, such as administrator device 125, to cause the user's device to enter into a particular mode, or to unlock a personal mode, thus authorizing the user to make personal annotations.

If the user device is not in a personal mode, then annotations provided by the user may be made visible, but are not necessarily currently visible, to other users. Thus, the annotations provided by the user when the user device is in a personal mode is transmitted to a server, such as communication session server 145, at operation 540. Once the server receives the annotations, the annotations may be stored for subsequent potential transmission to other users.

If the user device is in a personal mode, then any annotations made may be stored locally at operation 550. Thus, annotation data corresponding to personal annotations may not be made accessible to any network-accessible devices so that personal annotations may remain private and accessible only to the user. Alternatively, in some embodiments personal annotation data may be provided to a server, such as communication session server 145, so that the user may view his or her personal annotations on other devices once the user is authenticated. In such embodiments, personal annotation data may be stored separately from the public annotation data, and the personal annotation data may not be shared with other devices.

Referring to FIG. 6, FIG. 6 illustrates a hardware block diagram of a computing device 600 that may perform functions associated with operations discussed herein in connection with the techniques depicted in FIGS. 1-5. In various embodiments, a computing device, such as computing device 600 or any combination of computing devices 600, may be configured as any entity/entities as discussed for the techniques depicted in connection with FIG. 6 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computer device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided comprising: presenting a document to a plurality of user devices participating in a communication session, receiving annotations to the document from a plurality of users of the plurality of user devices during the communication session, selecting a subset of one or more users, and providing, to the plurality of user devices, the annotations associated with the subset of one or more users to cause the plurality of user devices to display the annotations of the subset of one or more users.

In another form, the method further includes disabling the annotations associated with the subset of one or more users from display by the plurality of user devices, selecting a different subset of one or more users, and providing, to the plurality of user devices, the annotations associated with the different subset of one or more users to cause the plurality of user devices to display the annotations of the different subset of one or more users.

In another form, the users include an administrator, and the subset of one or more users is selected based on input by the administrator.

In another form, the method further includes providing, to a user device of the administrator, the annotations of the plurality of users in response to receiving annotations to the document from the plurality of users.

In another form, the method further includes receiving from a user device of the administrator an indication of a particular user of the plurality of users that is responsible for each annotation.

In another form, the annotations include one or more of: a typewritten annotation, a freehand annotation, and a highlighting annotation.

In another form, the method further includes transmitting instructions to a user device of the plurality of user devices to cause the user device to receive personal annotations from a user of the user device, wherein the personal annotations are stored locally on the user device.

In one form, a computer system is provided, comprising: one or more computer processors; one or more computer readable storage media; program instructions stored on the one or more computer readable storage media for execution by at least one of the one or more computer processors, the program instructions comprising instructions to: present a document to a plurality of user devices participating in a communication session, receive annotations to the document from a plurality of users of the plurality of user devices during the communication session, select a subset of one or more users, and provide, to the plurality of user devices, the annotations associated with the subset of one or more users to cause the plurality of user devices to display the annotations of the subset of one or more users.

In one form, one or more computer readable storage media is provided, the one or more computer readable storage media collectively having program instructions embodied therewith, the program instructions executable by a computer to cause the computer to: present a document to a plurality of user devices participating in a communication session, receive annotations to the document from a plurality of users of the plurality of user devices during the communication session, select a subset of one or more users, and provide, to the plurality of user devices, the annotations associated with the subset of one or more users to cause the plurality of user devices to display the annotations of the subset of one or more users.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
presenting content to a plurality of user devices participating in a communication session;
receiving annotations to the content from a plurality of users of the plurality of user devices during the communication session;
selecting a subset of one or more users;
providing, to the plurality of user devices, the annotations associated with the subset of one or more users to cause the plurality of user devices to display the annotations of the subset of one or more users; and
transmitting instructions to a user device of the plurality of user devices to cause the user device to receive personal annotations from a user of the user device, wherein the personal annotations are stored locally on the user device.

2. The computer-implemented method of claim 1, further comprising:
disabling the annotations associated with the subset of one or more users from display by the plurality of user devices;
selecting a different subset of one or more users; and
providing, to the plurality of user devices, the annotations associated with the different subset of one or more users to cause the plurality of user devices to display the annotations of the different subset of one or more users.

3. The computer-implemented method of claim 1, wherein the users include an administrator, and wherein the subset of one or more users is selected based on input by the administrator.

4. The computer-implemented method of claim 3, further comprising:
providing, to a user device of the administrator, the annotations of the plurality of users in response to receiving annotations to the content from the plurality of users.

5. The computer-implemented method of claim 3, further comprising:
receiving from a user device of the administrator an indication of a particular user of the plurality of users that is responsible for each annotation.

6. The computer-implemented method of claim 1, wherein the annotations include one or more of: a typewritten annotation, a freehand annotation, and a highlighting annotation.

7. The computer-implemented method of claim 1, wherein a user device of an administrator provides input to cause the instructions to be transmitted to the user device of the plurality of user devices to cause the user device to receive personal annotations from the user of the user device.

8. An apparatus comprising:
one or more computer processors;
a network interface configured to enable network communications;
one or more computer readable storage media; and
program instructions stored on the one or more computer readable storage media for execution by at least one of the one or more computer processors, the program instructions comprising instructions to:
present content to a plurality of user devices participating in a communication session;
receive annotations to the content from a plurality of users of the plurality of user devices during the communication session;
select a subset of one or more users;
provide, to the plurality of user devices, the annotations associated with the subset of one or more users to cause the plurality of user devices to display the annotations of the subset of one or more users; and
transmit instructions to a user device of the plurality of user devices to cause the user device to receive personal annotations from a user of the user device, wherein the personal annotations are stored locally on the user device.

9. The apparatus of claim 8, wherein the program instructions further comprise instructions to:
disable the annotations associated with the subset of one or more users from display by the plurality of user devices;
select a different subset of one or more users; and
provide, to the plurality of user devices, the annotations associated with the different subset of one or more users to cause the plurality of user devices to display the annotations of the different subset of one or more users.

10. The apparatus of claim 8, wherein the users include an administrator, and wherein the subset of one or more users is selected based on input by the administrator.

11. The apparatus of claim 10, wherein the program instructions further comprise instructions to:
provide, to a user device of the administrator, the annotations of the plurality of users in response to receiving annotations to the content from the plurality of users.

12. The apparatus of claim 10, wherein the program instructions further comprise instructions to:
receive from a user device of the administrator an indication of a particular user of the plurality of users that is responsible for each annotation.

13. The apparatus of claim 8, wherein the annotations include one or more of: a typewritten annotation, a freehand annotation, and a highlighting annotation.

14. The apparatus of claim 8, wherein a user device of an administrator provides input to cause the instructions to be transmitted to the user device of the plurality of user devices to cause the user device to receive personal annotations from the user of the user device.

15. A computer program product comprising one or more computer readable storage media collectively having program instructions embodied therewith, the program instructions executable by a computer to cause the computer to:
present content to a plurality of user devices participating in a communication session;
receive annotations to the content from a plurality of users of the plurality of user devices during the communication session;
select a subset of one or more users;
provide, to the plurality of user devices, the annotations associated with the subset of one or more users to cause the plurality of user devices to display the annotations of the subset of one or more users; and
transmit instructions to a user device of the plurality of user devices to cause the user device to receive personal annotations from a user of the user device, wherein the personal annotations are stored locally on the user device.

16. The computer program product of claim 15, wherein the program instructions further cause the computer to:
disable the annotations associated with the subset of one or more users from display by the plurality of user devices;
select a different subset of one or more users; and
provide, to the plurality of user devices, the annotations associated with the different subset of one or more users to cause the plurality of user devices to display the annotations of the different subset of one or more users.

17. The computer program product of claim 15, wherein the users include an administrator, and wherein the subset of one or more users is selected based on input by the administrator.

18. The computer program product of claim 17, wherein the program instructions further cause the computer to:
provide, to a user device of the administrator, the annotations of the plurality of users in response to receiving annotations to the content from the plurality of users.

19. The computer program product of claim 17, wherein the program instructions further comprise instructions to:
receive from a user device of the administrator an indication of a particular user of the plurality of users that is responsible for each annotation.

20. The computer program product of claim 15, wherein the annotations include one or more of: a typewritten annotation, a freehand annotation, and a highlighting annotation.
